(19) United States
(12) Patent Application Publication
(10) Pub. No.: US 2012/0256515 A1
(43) Pub. Date: Oct. 11, 2012

(54) SPINDLE MOTOR

(75) Inventors: Kyung Su PARK, Gyunggi-do (KR); Young Sun YOO, Gyunggi-do (KR); Ho Jun YOO, Gyunggi-do (KR)

(73) Assignee: SAMSUNG ELECTRO-MECHANICS CO., LTD., Gyunggi-do (KR)

(21) Appl. No.: 13/151,091

(22) Filed: Jun. 1, 2011

(30) Foreign Application Priority Data
Apr. 5, 2011 (KR) 10-2011-0031359

(51) Int. Cl. H02K 3/34

(52) U.S. Cl. 310/216.115

(57) ABSTRACT

Disclosed herein is a spindle motor configured of a rotating part including a shaft and a magnet and a fixing part including a bearing supporting the shaft and an armature facing the magnet, the rotating part being rotated by electromagnetic force between the magnet and the armature, wherein the fixing part includes: a base plate supporting the shaft; a bearing holder mounted on an upper portion of the base plate and fixed to an outer diameter of the bearing; and a flexible printed circuit board attached on upper portions of the base plate and the bearing holder so that it is disposed between the base plate and the armature and the bearing holder and the armature, thereby insulating the base plate and the bearing holder from the armature.

### CROSS REFERENCE TO RELATED APPLICATION

This application claims the benefit of Korean Patent Application No. 10-2011-0031359, filed on Apr. 5, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, in a spindle motor, a bearing having a shaft received therein rotatably supports the shaft, such that a high degree of rotating characteristics may be maintained.

Therefore, the spindle motor has been widely used as a driving unit of a hard disk drive, an optical disk drive, and other recording media requiring high speed rotation.

In the case of an optical disk drive (ODD) motor among the spindle motors according to the prior art, in order to prevent a defect due to short-circuit between a coil and a bearing holder and between the coil and a base plate, an insulating sheet has been inserted therebetween or a length of a coil coating has been controlled.

However, the insertion of the insulating sheet causes an increase in a material cost and deterioration in workability. In addition, it is difficult to control the length of the coil coating.

Therefore, research into a spindle motor capable of preventing the defect due to the short-circuit between the coil generating an electromagnetic field of a stator and the base plate fixing the electromagnetic field and between the coil and the bearing holder in accordance with the miniaturization and lightness of the ODD motor has been actively conducted.

### SUMMARY OF THE INVENTION

The present invention has been made in an effort to provide a spindle motor capable of preventing a defect due to contact between an armature and a base plate and between the armature and a bearing holder during the driving thereof.

According to a preferred embodiment of the present invention, there is provided a spindle motor configured of a rotating part including a shaft and a magnet and a fixing part including a bearing supporting the shaft and an armature facing the magnet, the rotating part being rotated by electromagnetic force between the magnet and the armature, wherein the fixing part includes: a base plate supporting the shaft; a bearing holder mounted on an upper portion of the base plate and fixed to an outer diameter of the bearing; and a flexible printed circuit board attached on upper portions of the base plate and the bearing holder so that it is disposed between the base plate and the armature and the bearing holder and the armature, thereby insulating the base plate and the bearing holder from the armature.

The flexible printed circuit board may be attached to the base plate and the bearing holder by attaching a portion thereof to the base plate, vertically assembling the bearing holder at the center of the base plate, and then attaching an inner diameter portion thereof to the upper portion of the bearing holder.

The inner diameter portion of the flexible printed circuit board may be attached to a position facing the bearing holder attached to the upper portion of the base plate.

The inner diameter portion of the flexible printed circuit board may have a groove formed between the bearing holder and the base plate.

### BRIEF DESCRIPTION OF THE DRAWINGS

FIG. 1 is a cross-sectional view of a spindle motor according to a preferred embodiment of the present invention; and

FIG. 2 is a partially enlarged view of a spindle motor according to a preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

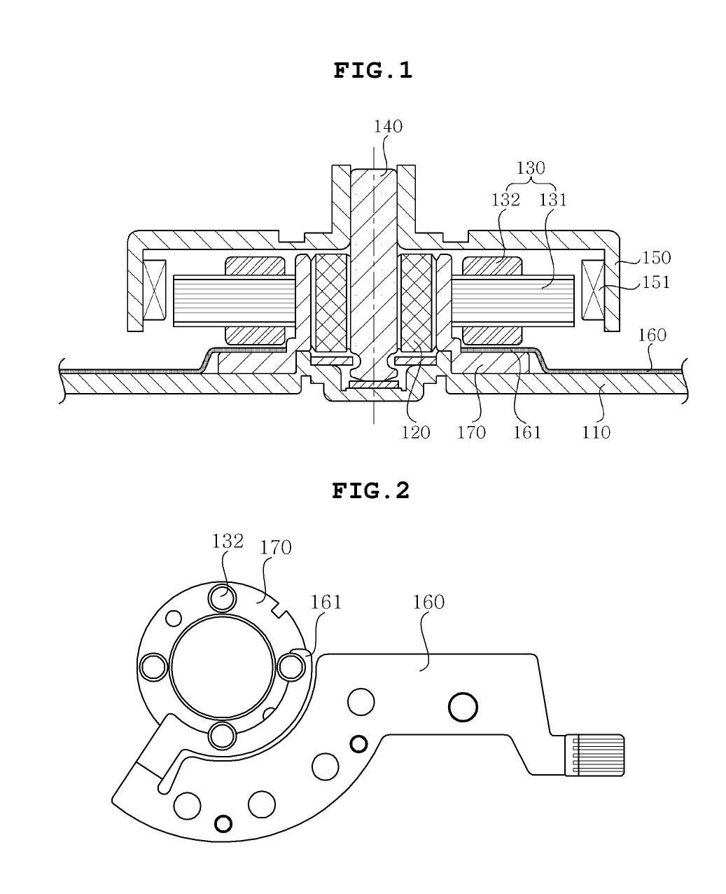

FIG. 1 is a cross-sectional view of a spindle motor according to a preferred embodiment of the present invention.

As shown in FIG. 1, a spindle motor 100 according to a preferred embodiment of the present invention includes a base plate 110, a bearing 120, an armature 130, a shaft 140, a hub 150, a flexible printed circuit board 160, and a bearing holder 170.

The base plate 110, which is to fixedly support the entire spindle motor 100, is fixedly mounted in a device such as an optical disk drive, or the like, having the spindle motor 100 mounted therein. Here, the base plate 110 is formed of a light weight material such as an aluminum plate, an aluminum alloy plate, or the like. However, the base plate 110 may also be formed of a steel plate.

The bearing 120, which is to rotatably support the shaft 140, has the entirely hollow cylindrical shape and is formed on an outer diameter of the shaft 140.

The armature 130, which is to form an electric field by receiving external power in order to rotate the hub 150 having an optical disk mounted thereon, is configured of a core 131 formed by stacking a plurality of sheets of thin metal plate and a coil 132 wound many times around the core 131.

The coil 132 is wound around the core 131 and forms an electric field by a current applied from the outside thereto, thereby rotating the hub 150 by electromagnetic force formed between the coil 132 and a magnet 151 of the hub 150.

The shaft 140, which is to axially support the hub 150, is inserted into an inner diameter portion of the bearing 120 and is rotatably supported by the bearing 120.

The hub 150, which is to have a disk (not shown) such as an optical disk, or the like, mounted thereon and rotate the disk, includes a circular plate part (not shown) having the shaft 140 fixedly mounted thereon and an annular edge part (not shown) extending from a distal end of the circular plate part.

The flexible printed circuit board 160, which is a board having electrical circuits and various electrical elements mounted thereon and having flexibility, is partially mounted on the base plate 110 and transceives an electrical signal.

The bearing holder 170 is fixedly coupled to an upper portion of the center of the base plate 110 simultaneously with enclosing an outer diameter of the bearing 120.

The spindle motor as described above includes the base plate 110 having the bearing holder 170 coupled to the upper portion of the center thereof, the armature 130 disposed on an upper side of the base plate 110 and the bearing holder 170, and the flexible printed circuit board 160 disposed on an upper portion of the bearing holder 170 so as to insulate a distal end of the coil 132 of the armature 130 from the bearing holder 170 and the base plate 110 during the driving thereof.

FIG. 2 is partially enlarged view of a spindle motor according to a preferred embodiment of the present invention in which the flexible printed circuit board 160 is disposed on the upper portion of the bearing holder 170 so that the distal end of the coil 132 of the armature 130 does not contact the bearing holder 170 and the base plate (not shown) during the driving of the spindle motor.

As shown in FIG. 2, a spindle motor according to a preferred embodiment of the present invention has a structure in which the flexible printed circuit board 160 is attached to an upper portion of the base plate (not shown) and the bearing holder 170 is assembled at an upper portion of the center of the base plate (not shown).

Here, an inner diameter portion 161 of the flexible printed circuit board 160 is folded toward the outside, before the bearing holder 170 is assembled at the upper portion of the center of the base plate (not shown), and the inner diameter portion 161 of the flexible printed circuit board is attached to a position in which the distal end of the coil 132 and the bearing holder 170 face each other and a position in which insulation may be made, after the assembly of the bearing holder 170 is finished and before the armature 130 is assembled.

The inner diameter portion 161 of the flexible printed circuit board 160 is attached to the bearing holder 170 so as to face the bearing holder 170 attached to the upper portion of the base plate (not shown) and the armature 130 is then assembled at an outer diameter of the bearing holder 170, thereby making it possible to previously prevent a problem such as a short-circuit, or the like, generated due to the contact between the coil 132 of the armature 130 and the base plate (not shown) or the bearing holder 170 during the driving of the motor.

Here, the flexible printed circuit board 160 may also have a groove formed between the bearing holder 170 and the base plate (not shown) so that the inner diameter portion 161 thereof may be easily folded or assembled before the bearing holder 170 is vertically assembled at the center of the base plate (not shown), wherein the groove has a thickness corresponding to a knife thickness.

As described above, the inner diameter portion 161 of the flexible printed circuit board 160 is folded, before the bearing holder 170 is assembled at the upper portion of the center of the base plate (not shown), and the inner diameter portion 161 of the flexible printed circuit board 160 is attached to a position in which the bearing holder 170 and the armature 130 may be in contact with each other, after the assembly of the bearing holder 170 is finished and before the armature 130 is assembled, thereby making it possible to easily prevent the contact between the coil 132 and the bearing holder 170 and between the coil 132 and the base plate 110 and remove the necessity for a separate member for insulation.

In addition, the insulation is simply made using the inner diameter portion 161 of the flexible printed circuit board 160 made of a flexible material, thereby making it possible to improve workability and reduce a cost.

In the spindle motor according to the preferred embodiment of the present invention, a portion of the flexible printed circuit board is attached to the upper portion of the base plate, the inner diameter portion of the flexible printed circuit board is folded before the bearing holder is assembled at the upper portion of the center of the base plate, and the inner diameter portion of the flexible printed circuit board is attached to a position in which the armature may contact the bearing holder and the base plate, after the assembly of the bearing holder is finished and before the armature is assembled, thereby making it possible to easily prevent the contact between the coil and the bearing holder and between the coil and the base plate and prevent the short-circuit due to the contact.

In addition, the insulation is simply made using the inner diameter portion of the flexible printed circuit board, thereby making it possible to improve workability and there is no need for a separate member for insulation, thereby making it possible to reduce a cost.

Although the embodiment of the present invention has been disclosed for illustrative purposes, it will be appreciated that a spindle motor according to the invention is not limited thereby, and those skilled in the art will appreciate that various modifications, additions and substitutions are possible, without departing from the scope and spirit of the invention.

Accordingly, such modifications, additions and substitutions should also be understood to fall within the scope of the present invention.

What is claimed is:

1. A spindle motor configured of a rotating part including a shaft and a magnet and a fixing part including a bearing supporting the shaft and an armature facing the magnet, the rotating part being rotated by electromagnetic force between the magnet and the armature, wherein the fixing part includes:
a base plate supporting the shaft;
a bearing holder mounted on an upper portion of the base plate and fixed to an outer diameter of the bearing; and
a flexible printed circuit board attached on upper portions of the base plate and the bearing holder so that it is disposed between the base plate and the armature and the bearing holder and the armature, thereby insulating the base plate and the bearing holder from the armature.

2. The spindle motor as set forth in claim 1, wherein the flexible printed circuit board is attached to the base plate and the bearing holder by attaching a portion thereof to the base plate, vertically assembling the bearing holder at the center of the base plate, and then attaching an inner diameter portion thereof to the upper portion of the bearing holder.

3. The spindle motor as set forth in claim 2, wherein the inner diameter portion of the flexible printed circuit board is attached to a position facing the bearing holder attached to the upper portion of the base plate.

4. The spindle motor as set forth in claim 2, wherein the inner diameter portion of the flexible printed circuit board has a groove formed between the bearing holder and the base plate.
